(19) United States
(12) Patent Application Publication
(10) Pub. No.: US 2019/0037191 A1
(43) Pub. Date: Jan. 31, 2019

(54) WHITE BALANCE ADJUSTING APPARATUS, OPERATION METHOD THEREOF, AND NON-TRANSITORY COMPUTER READABLE MEDIUM

(71) Applicant: FUJIFILM Corporation, Tokyo (JP)

(72) Inventor: Yuya Nishio, Saitama-shi (JP)

(73) Assignee: FUJIFILM Corporation, Tokyo (JP)

(21) Appl. No.: 16/146,034

(22) Filed: Sep. 28, 2018

Related U.S. Application Data
(63) Continuation of application No. PCT/JP2017/006234, filed on Feb. 20, 2017.

(30) Foreign Application Priority Data
Mar. 31, 2016 (JP) 2016-073269

(51) Int. Cl. H04N 9/73; G06T 7/00; G06T 7/90

(52) U.S. Cl. CPC H04N 9/735; G06T 7/97; G06T 2207/20012; G06T 2207/20021; G06T 2207/30201; G06T 7/90

(57) ABSTRACT

A non-emission image is obtained by a non-emission image obtaining unit in a state in which a plurality of flash devices do not emit light. Pre-emission images are obtained by an emission image obtaining unit in a state in which the plurality of flash devices individually emits light. Flash light irradiation areas are specified by a flash light irradiation area specifying unit based on a signal value difference of a plurality of division areas of the non-emission image and each of the emission images. A priority area selecting unit selects a priority area to be used in white balance (WB) adjustment. A WB adjusting unit performs WB adjustment based on a signal value of the selected priority area.

### CROSS-REFERENCE TO RELATED APPLICATIONS

This application is a Continuation of PCT International Application No. PCT/JP2017/006234 filed on 20 Feb. 2017, which claims priority under 35 U.S.C § 119(a) to Japanese Patent Application No. 2016-073269 filed on 31 Mar. 2016. The above application is hereby expressly incorporated by reference, in its entirety, into the present application.

### BACKGROUND OF THE INVENTION

### 1. Field of the Invention

The present invention relates to a white balance adjusting apparatus, an operation method thereof, and a non-transitory computer readable medium which adjust white balance at the time of imaging using a plurality of auxiliary light sources.

### 2. Description of the Related Art

Human visual perception has color constancy. Accordingly, it is possible to perceive an original color of a subject irrespective of a difference of ambient light such as electric light, fluorescent light, or sunlight. In contrast, an image using an imaging device such as a digital camera is directly influenced by the ambient light. Thus, the imaging device has a white balance adjusting function of performing color conversion on the image such that the human can see a natural image by correcting the influence of the ambient light.

For example, a main subject is irradiated with mixed light of the ambient light with flash light on the image captured by the imaging device by using a flash device as an auxiliary light source. A background is less influenced by the flash light, and is mostly irradiated with the ambient light.

For example, in auto white balance adjustment at the time of general flash imaging, a ratio of the ambient light to the flash light (hereinafter, referred to as a mixed light ratio) is calculated, and white balance is adjusted according to the mixed light ratio, as described in JP2010-193048A. There is a tendency to irradiate the main subject with the flash light at the time of single flash imaging using one flash. Thus, the main subject has an appropriate tint by performing the auto white balance adjustment according to the mixed light ratio of a portion irradiated with the flash light.

### SUMMARY OF THE INVENTION

However, in the imaging using a plurality of auxiliary light sources, for example, a plurality of flash devices, the portion strongly irradiated with the flash light may not be the main subject. For example, in a case where there is the plurality of auxiliary light sources such as the flash device that irradiates the main subject with the flash light and the flash device that irradiates the background with the flash light, the flash device that irradiates the background may strongly emit the light. In this case, in a case where the auto white balance adjustment is performed depending on the mixed light ratio in the portion strongly irradiated with the flash light, the image has a tint that emphasizes the background, and thus, the tint of the main subject becomes bad.

The present invention has been made in view of the circumstances, and an object of the present invention is to provide a white balance adjusting apparatus, an operation method thereof, and a non-transitory computer readable medium which allow a main subject to have an appropriate tint at the time of imaging using a plurality of auxiliary light sources.

In order to achieve the object, a white balance adjusting apparatus of the present invention comprises a non-emission image obtaining unit, an emission image obtaining unit, an auxiliary light irradiation area specifying unit, a priority area selecting unit, a white balance adjustment value calculating unit, and a white balance adjusting unit. The non-emission image obtaining unit obtains a non-emission image by imaging a subject in a state in which a plurality of auxiliary light sources does not emit light. The emission image obtaining unit obtains emission images of the auxiliary light sources by imaging the subject in a state in which the plurality of auxiliary light sources individually emits light. The auxiliary light irradiation area specifying unit divides the non-emission image and each of the emission images into a plurality of division areas, and specifies auxiliary light irradiation areas irradiated with auxiliary light of each of the auxiliary light sources based on a signal value difference of each division area between the state in which the plurality of auxiliary light sources individually emits light and the state in which the plurality of auxiliary light sources does not emit light. The priority area selecting unit selects a priority area to be used in white balance adjustment from the auxiliary light irradiation areas of each of the auxiliary light sources. The white balance adjustment value calculating unit calculates a white balance adjustment value based on a signal value of the selected priority area. The white balance adjusting unit performs adjustment using the white balance adjustment value.

It is preferable that the white balance adjusting apparatus further comprises a selection input unit that inputs a command to select one or a plurality of the priority areas from the auxiliary light irradiation areas of each of the auxiliary light sources to the priority area selecting unit.

It is preferable that the priority area selecting unit includes an auxiliary light irradiation area addition unit, a face area detecting unit, and a priority area determining unit. The auxiliary light irradiation area addition unit calculates an addition area obtained by adding the auxiliary light irradiation areas. The face area detecting unit detects a face area from the non-emission image or the emission images. The priority area determining unit specifies which of the auxiliary light irradiation areas the face area detected by the face area detecting unit is present, excludes the auxiliary light irradiation areas which do not include the face area from the addition area, and determines that the area remaining after the excluding is the priority area.

It is preferable that the priority area selecting unit includes an auxiliary light irradiation area addition unit and a priority area determining unit. The auxiliary light irradiation area addition unit calculates an addition area obtained by adding the auxiliary light irradiation areas. The priority area determining unit determines the priority area based on previously stored pixel information of the auxiliary light source and the addition area.

The priority area determining unit sets a determination range in a color space by using the previously stored light source color information of the auxiliary light, light source color information of ambient light obtained from the non-emission image, and pixel information at the time of non-emission of the auxiliary light irradiation areas. The priority area determining unit excludes the auxiliary light irradiation areas from the addition area in a case where pixel information based on the emission image is positioned out of the determination range. The priority area determining unit determines that the area remaining after the excluding is the priority area.

It is preferable that the priority area is determined based on the non-emission signal value average, the signal value average prediction value at the time of emission of the auxiliary light source, and the emission signal value average. The light source color information of the auxiliary light is coordinates indicating a color of the auxiliary light in a color space. The light source color information of the ambient light is coordinates which are obtained based on the non-emission image and indicate a color of the ambient light in the color space. The pixel information at the time of the non-emission of the auxiliary light irradiation areas is coordinates which are obtained based on the non-emission image and indicate a non-emission signal value average of the auxiliary light irradiation areas in the color space. The priority area determining unit calculates the emission signal value average which is the signal value average of the auxiliary light irradiation areas in the color space based on the emission image. The priority area determining unit calculates a difference vector which is a difference between the light source color information of the auxiliary light and the light source color information of the ambient light, and obtains the signal value average prediction value at the time of the emission of the auxiliary light source by adding the difference vector to the coordinates of the non-emission signal value average.

It is preferable that in a case where the emission signal value average is present out of the determination range having the non-emission signal value average and the signal value average prediction value at the time of the emission of the auxiliary light source as both ends, the priority area determining unit excludes the auxiliary light irradiation areas from the addition area, and selects the area remaining after the excluding as the priority area.

It is preferable that the priority area selecting unit includes an auxiliary light irradiation area addition unit, a spatial frequency calculating unit, and a priority area determining unit. The auxiliary light irradiation area addition unit calculates an addition area obtained by adding the auxiliary light irradiation areas. The spatial frequency calculating unit calculates a spatial frequency of the auxiliary light irradiation areas using each of the auxiliary light sources on the non-emission image. The priority area determining unit excludes the auxiliary light irradiation areas whose spatial frequency is equal to or smaller than a predetermined value from the addition area in a case where the spatial frequency of the auxiliary light irradiation areas using each of the auxiliary light sources is equal to or smaller than the predetermined value. The priority area determining unit determines that the auxiliary light irradiation area remaining after the excluding is the priority area.

It is preferable that the white balance adjustment value calculating unit obtains an emission image at the time of actual emission obtained by imaging the subject in a state in which the auxiliary light source emits light, and calculates the white balance adjustment value based on a signal value in the priority area of the emission image and a signal value in the priority area of the non-emission image.

It is preferable that the white balance adjusting unit obtains an actual emission image obtained by imaging the subject in a state in which the plurality of auxiliary light sources emits light with an emission amount at the time of actual emission and performs the white balance adjustment using the white balance adjustment value on the actual emission image.

An operation method of a white balance adjusting apparatus of the present invention comprises a non-emission image obtaining step, an emission image obtaining step, an auxiliary light irradiation area specifying step, a priority area selecting step, a white balance adjustment value calculating step, and a white balance adjusting step. A non-transitory computer readable medium for storing a computer-executable program for execution of white balance adjustment of the present invention causes the computer to perform the above steps. In the non-emission image obtaining step, a non-emission image is obtained by imaging a subject in a state in which a plurality of auxiliary light sources does not emit light. In the emission image obtaining step, emission images of the auxiliary light sources are obtained by imaging the subject in a state in which the plurality of auxiliary light sources individually emits light. In the auxiliary light irradiation area specifying step, the non-emission image and each of the emission images are divided into a plurality of division areas, and auxiliary light irradiation areas irradiated with auxiliary light of each of the auxiliary light sources are specified based on a signal value difference of each division area between the state in which the plurality of auxiliary light sources individually emits light and the state in which the plurality of auxiliary light sources does not emit light. In the priority area selecting step, a priority area to be used in white balance adjustment is selected from the auxiliary light irradiation areas of each of the auxiliary light sources. In the white balance adjustment value calculating step, a white balance adjustment value is calculated based on a signal value of the selected priority area. In the white balance adjusting step, adjustment using the white balance adjustment value is performed.

According to the present invention, it is possible to provide a white balance adjusting apparatus, an operation method thereof, and a non-transitory computer readable medium which allow a main subject to have an appropriate tint at the time of imaging using a plurality of auxiliary light sources.

### BRIEF DESCRIPTION OF THE DRAWINGS

FIG. 1 is a perspective view showing the overall imaging system to which an embodiment of a white balance adjusting apparatus of the present invention is applied, and shows a state in which a pre-emission image is captured by turning on a flash light emitting unit of a camera.

FIG. 2 is a functional block diagram of the camera and a flash device.

FIG. 3 is a functional block diagram of a main controller and a digital signal processing unit.

FIG. 4 is a flowchart showing WB adjustment in imaging using a plurality of flash devices.

FIG. 5 is an explanatory diagram showing the specification of flash light irradiation areas.

FIG. 6 is an explanatory diagram showing a selection input of a priority area.

FIG. 7 is an overall perspective view showing a state in which the pre-emission image is captured by turning on a second flash device.

FIG. 8 is a functional block diagram showing a priority area selecting unit according to a second embodiment.

FIG. 9 is a flowchart showing WB adjustment according to the second embodiment.

FIG. 10 is an explanatory diagram showing the detection of a face area.

FIG. 11 is a diagram for describing a method of determining a priority area in a case where flash light irradiation areas are partially overlapped.

FIG. 12 is a side view showing a flash device including a special effect filter according to a third embodiment.

FIG. 13 is a functional block diagram showing a priority area selecting unit of the third embodiment.

FIG. 14 is a flowchart showing WB adjustment according to the third embodiment.

FIG. 15 is a diagram showing light source color information of ambient light, light source color information of flash light, and a difference vector in a color space having R/G and B/G on a coordinate axis.

FIG. 16 is a diagram showing a signal value average at the time of non-emission of flash light irradiation areas and signal value average prediction value at the time of performing irradiation using flash light in a state in which there is no special effect filter in the color space having R/G and B/G on the coordinate axis.

FIG. 17 is a diagram showing the determination of whether or not the flash device is a flash device to which the special effect filter is attached based on whether or not a signal value average at the time of pre-emission is present in a determination range H1 in the color space having R/G and B/G on the coordinate axis.

FIG. 18 is a diagram showing a determination range H2 according to Modification Example 1.

FIG. 19 is a diagram showing a determination range H3 according to Modification Example 2.

FIG. 20 is a diagram showing a determination range H4 according to Modification Example 3.

FIG. 21 is a diagram showing a determination range H5 according to Modification Example 4.

FIG. 22 is a diagram showing a determination range H6 according to Modification Example 5.

FIG. 23 is a functional block diagram showing a priority area selecting unit according to a fourth embodiment.

FIG. 24 is a flowchart showing WB adjustment according to the fourth embodiment.

### DESCRIPTION OF THE PREFERRED EMBODIMENTS

### First Embodiment

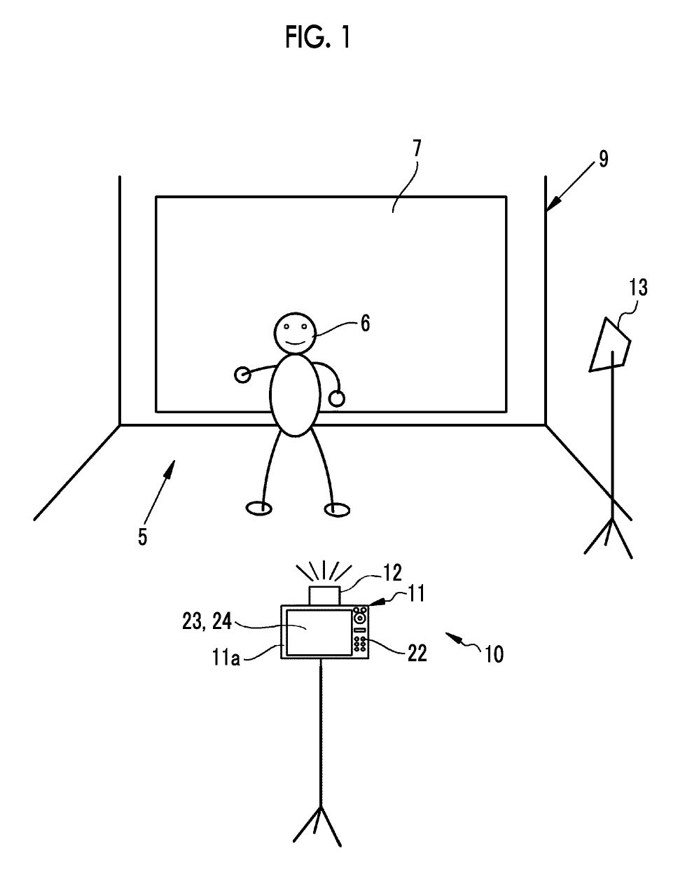

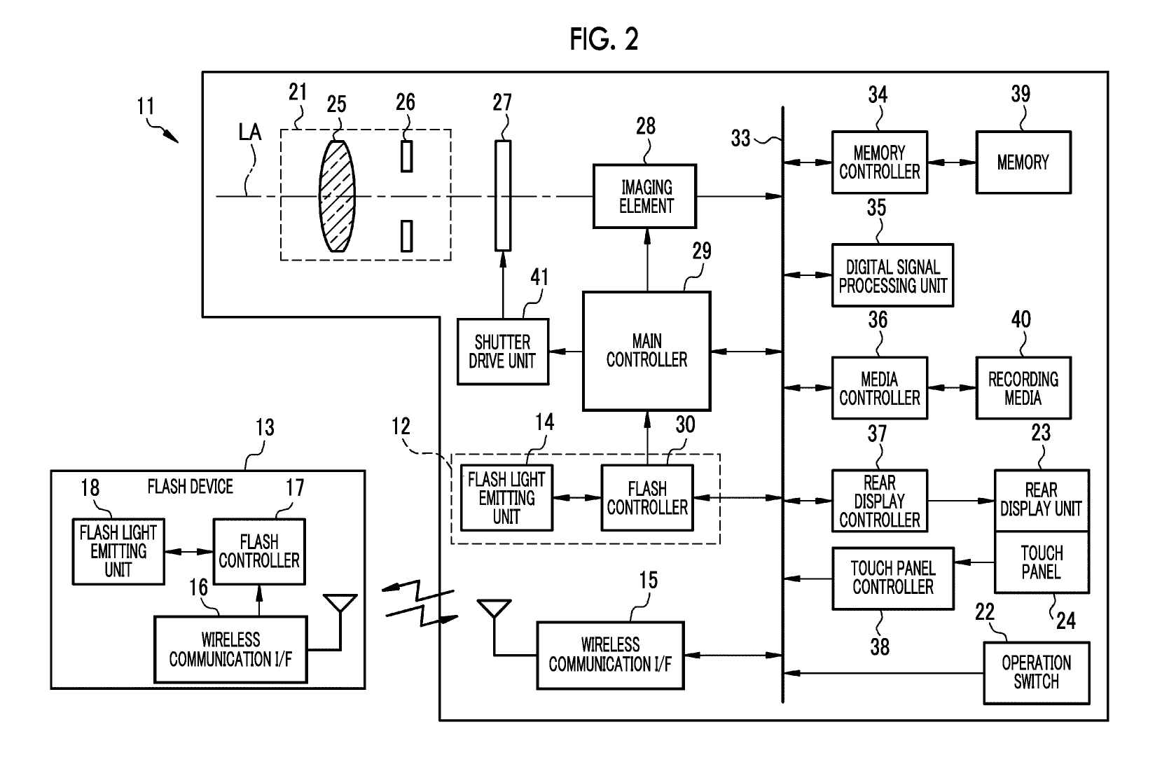

FIG. 1 is an overall configuration diagram of an imaging system 10 to which an embodiment of a white balance (hereinafter, referred to as WB) adjusting apparatus of the invention is applied. For example, the imaging system 10 is used in an imaging studio 9 by using a plurality of flash devices 12 and 13 as auxiliary light sources. The imaging system 10 includes a digital camera (hereinafter, simply referred to as a camera) 11, and flash devices 12 and 13. The flash device 12 including a flash light emitting unit 14 (see FIG. 2) is built in the camera 11. The built-in flash device 12 functions as a first auxiliary light source in the imaging system 10. The flash device 13 is provided separately from the camera 11, and functions as a second auxiliary light source in the imaging system 10.

In the imaging system 10, when multi-illumination imaging is performed, the camera 11 controls a turning-on timing by transmitting a control signal to the first auxiliary light source (first flash device 12) and the second auxiliary light source (second flash device 13). The first flash device 12 irradiates a main subject 6 among subjects 5 with flash light, and the second flash device 13 irradiates a backdrop 7 disposed behind the main subject 6 among the subjects 5 with flash light. Although it has been described in the present embodiment that the flash device 12 built in the camera 11 is used as the first auxiliary light source, a flash device provided separately from the camera 11 or a flash device provided integrally with the camera 11 so as to be detachably attached may be used similarly to the second auxiliary light source.

As shown in FIG. 2, the camera 11 and the flash device 13 include wireless communication interfaces (I/F) 15 and 16, respectively, and thus, the camera 11 and the flash device 13 can wirelessly communicate with each other. The camera and the flash device may perform wired communication instead of the wireless communication.

The flash device 13 includes a flash controller 17 and a flash light emitting unit 18 in addition to the wireless communication I/F 16. The flash device 13 receives a light amount adjusting signal sent from the camera 11 through the wireless communication I/F 16. The flash controller 17 controls the flash light emitting unit 18 to turn on the flash light emitting unit 18 according to the light amount adjusting signal. The turning-on of the flash light emitting unit 18 is flash emission of which light emission time has a unit of microseconds. The same is true of the flash light emitting unit 14 of the flash device 12 of the camera 11.

The camera 11 includes a lens barrel 21, an operation switch 22, and a rear display unit 23. The lens barrel 21 is provided on a front surface of a camera main body 11a (see FIG. 1), and holds an imaging optical system 25 and a stop 26.

The operation switch 22 is provided in plural on an upper portion or a rear surface of the camera main body 11a. The operation switch 22 receives an input operation for power turning ON and OFF operations, a release operation, and various settings. The rear display unit 23 is provided on the rear surface of the camera main body 11a, and displays images or live preview images obtained in various imaging modes and menu screens for performing various settings. A touch panel 24 is provided on a front surface of the rear display unit 23. The touch panel 24 is controlled by a touch panel controller 38, and transmits a command signal input through a touch operation to a main controller 29.

A shutter 27 and an imaging element 28 are disposed behind the imaging optical system 25 and the stop 26 in order along an optical axis LA of the imaging optical system 25. For example, the imaging element 28 is a complementary metal-oxide-semiconductor (CMOS) type image sensor of a single-plate color imaging type having red, green, and blue (RGB) color filters. The imaging element 28 images a subject image formed on an imaging surface by the imaging optical system 25, and outputs imaging signals.

The imaging element 28 includes a noise removing circuit, an autogain controller, and a signal processing circuit such as an analog/digital (A/D) conversion circuit (all are not shown). The noise removing circuit performs a noise removing process on the imaging signals. The autogain controller amplifies the level of the imaging signal to an optimum value. The A/D conversion circuit converts the imaging signals to digital signals, and outputs the digital signals to the imaging element 28.

The imaging element 28, the main controller 29, and the flash controller 30 are connected to a bus 33. The flash controller 30 and the flash light emitting unit 14 constitute the flash device 12 built in the camera 11. In addition, a memory controller 34, a digital signal processing unit 35, a media controller 36, a rear display controller 37, and a touch panel controller 38 are connected to the bus 33.

A transitory storage memory 39 such as a synchronous dynamic random-access memory (SDRAM) is connected to the memory controller 34. The memory controller 34 inputs and stores image data which are digital imaging signals output from the imaging element 28 to the memory 39. The memory controller 34 outputs the image data stored in the memory 39 to the digital signal processing unit 35.

The digital signal processing unit 35 performs the known image processing such as matrix calculation, demosaicing, WB adjustment, y correction, brightness and color difference conversion, resizing, or compression on the image data input from the memory 39.

The media controller 36 controls the recording and reading of the image data in and from a recording media 40. For example, the recording media 40 is a memory card having a flash memory built therein. The media controller 36 records the image data compressed by the digital signal processing unit 35 in the recording media 40 in a predetermined file format.

The rear display controller 37 controls an image display on the rear display unit 23. Specifically, the rear display controller 37 generates video signals conforming to the National Television System Committee (NTSC) standard based on the image data generated by the digital signal processing unit 35, and outputs the generated video signals to the rear display unit 23.

The main controller 29 controls an imaging process of the camera 11. Specifically, the main controller controls the shutter 27 through a shutter drive unit 41 in response to a release operation. The main controller controls the driving of the imaging element 28 in synchronization with the operation of the shutter 27. The camera 11 can set various imaging modes. The main controller 29 can perform imaging in the various imaging modes by controlling an F number of the stop 26 or an exposure time of the shutter 27 according to the set imaging mode.

In the camera 11 according to the present embodiment, a multi-illumination imaging mode is prepared in addition to the various normal imaging modes. The multi-illumination imaging mode is selected at the time of imaging using a plurality of auxiliary light sources. In the multi-illumination imaging mode, an unavailable flash device which is an unavailable auxiliary light source which is not used in the calculation of the WB adjustment value is specified, the irradiation areas of the flash light of the specified unavailable flash device are excluded, the priority area to which the priority is given in the WB adjustment is determined, and the WB adjustment value is calculated based on the priority area. The WB adjustment is performed on an actual emission signal values obtained through the imaging of an actual emission image which is an image at the time of actual emission by using the calculated WB adjustment value.

The main controller 29 has a priority area selecting function in order to specify the priority area. In a case where the multi-illumination imaging mode is selected, a priority area selecting process is performed. In the present embodiment, the individual irradiation areas of the two flash devices 12 and 13 in the imaging range of the imaging element 28 are recognized by the user (photographer), and the priority area is selected by the user at the time of calculating the WB adjustment value in the priority area selecting process.

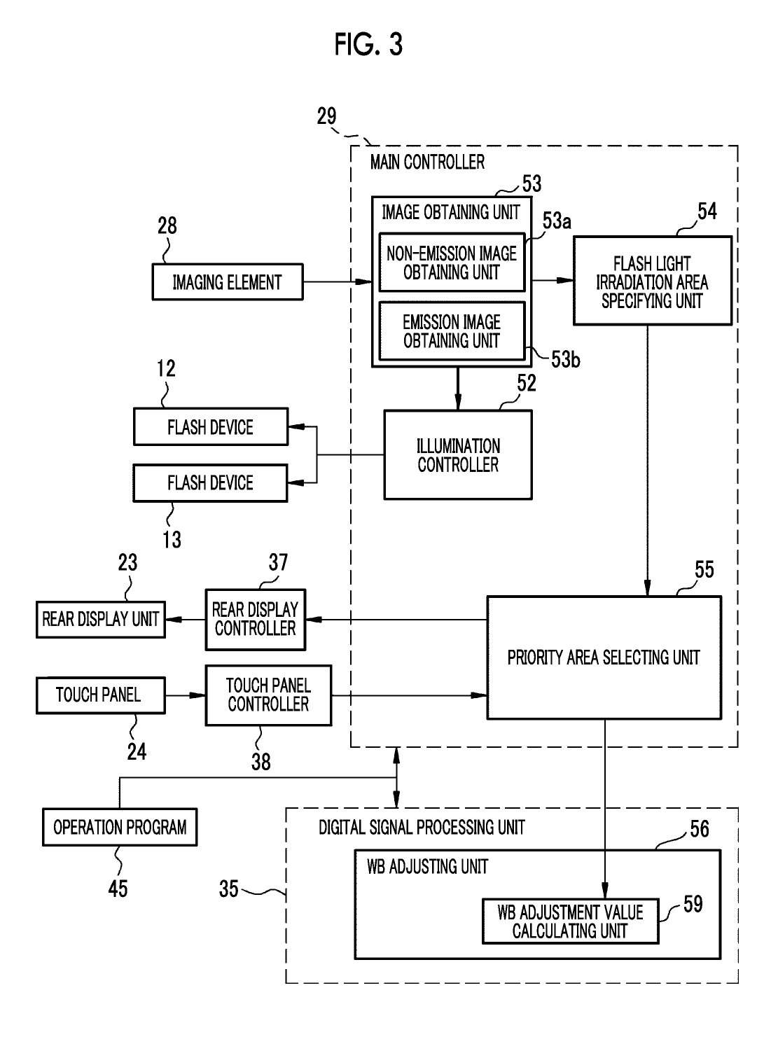

As shown in FIG. 3, in the multi-illumination imaging mode, the main controller 29 functions as an illumination controller 52, an image obtaining unit 53, a flash light irradiation area specifying unit (auxiliary light irradiation area specifying unit) 54, and a priority area selecting unit 55. These respective units are established by starting an operation program 45 stored in a nonvolatile memory (not shown) of the camera 11. Similarly, the digital signal processing unit 35 functions as the WB adjusting unit 56, and performs the WB adjustment by calculating the WB adjustment value based on the selected priority area.

The image obtaining unit 53 includes a non-emission image obtaining unit 53a and an emission image obtaining unit 53b. The WB adjusting unit 56 includes a WB adjustment value calculating unit 59.

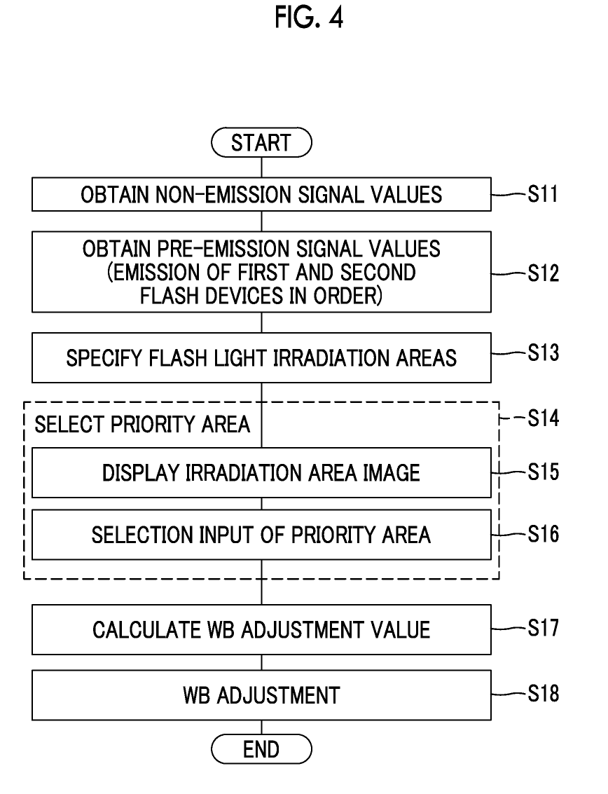

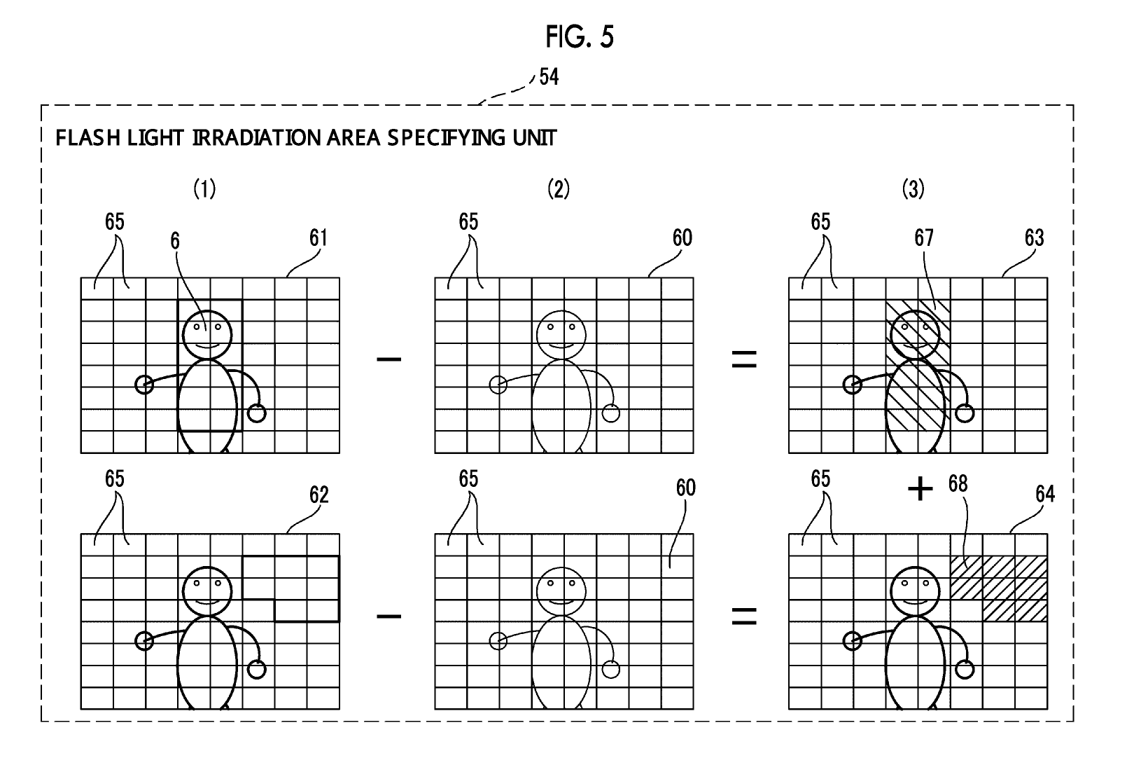

FIG. 4 is a flowchart showing the WB adjustment in the multi-illumination imaging mode. Initially, in non-emission signal value obtaining step S11, non-emission images 60 (see (2) of FIG. 5) which are images of the subjects 5 (see FIG. 1) are captured by the imaging element 28 and the non-emission image obtaining unit 53a of the image obtaining unit 53 in a state in which the flash devices 12 and 13 do not emit light. Non-emission signal values are obtained based on the non-emission images 60.

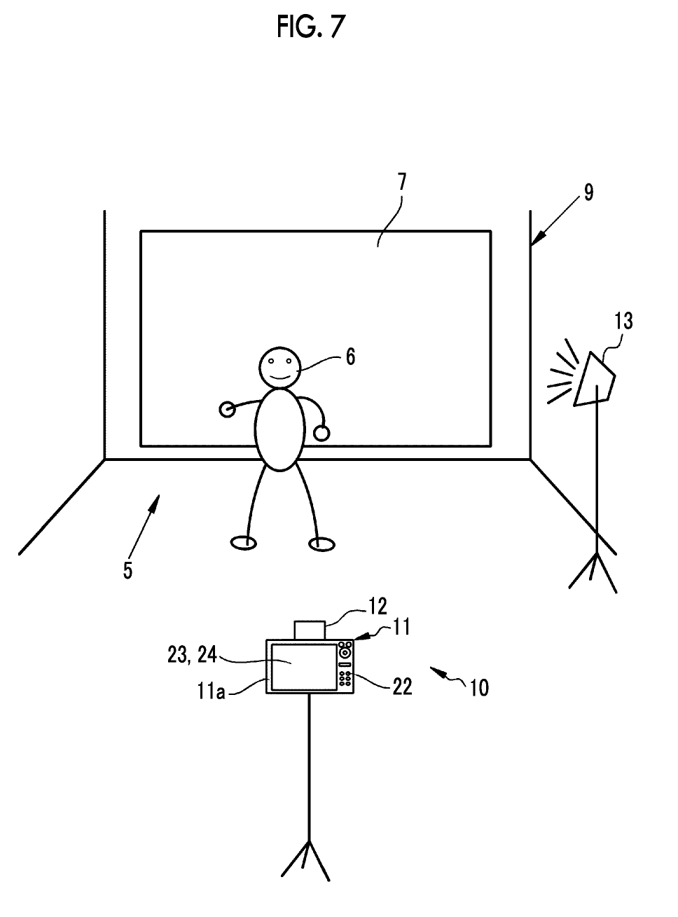

In pre-emission signal value obtaining step S12, pre-emission images 61 and 62 (see (1) of FIG. 5) which are images of the subjects 5 are captured by the imaging element 28 and the emission image obtaining unit 53b in a state in which the flash devices 12 and 13 do not individually emit light (individual emission aspect, see FIGS. 1 and 7), and emission signal values are obtained based on the pre-emission images 61 and 62. In this case, the illumination controller 52 controls the turning-on timings and light amounts of the flash devices 12 and 13 through the flash controller 30 or the wireless communication I/F 15. The emission image obtaining unit 53b selectively turns on the flash devices 12 and 13, and obtains the pre-emission image 61 or 62 which is the image of the subjects individually irradiated with the flash light.

FIG. 1 shows a state in which the first flash device 12 is turned on at the time of imaging in the studio. The first flash device 12 is set so as to irradiate the main subject 6 who stands in front of the backdrop 7 with the flash light. In this state, the first pre-emission image 61 (see (1) of FIG. 5) which is the pre-emission image at the time of emission of first flash light is captured.

FIG. 7 shows a state in which the second flash device 13 is turned on. The second flash device 13 is set so as to irradiate the backdrop 7 which is present on the back of the main subject 6 with second flash light from above on the right side. In this state, the second pre-emission image 62 (see (1) of FIG. 5) which is the pre-emission image at the time of emission of second flash light is captured.

In FIG. 4, in flash light irradiation area specifying step S13, flash light irradiation areas irradiated with the flash light from each flash device 12 or 13 are specified by the flash light irradiation area specifying unit 54.

FIG. 5 is an explanatory diagram showing a flash light irradiation area specifying process of the flash light irradiation area specifying unit 54 in flash light irradiation area specifying step S13. In the flash light irradiation area specifying process, flash light irradiation area specifying images 63 and 64 are created by using the non-emission images 60 and the pre-emission images 61 and 62.

For example, the non-emission images 60 and the pre-emission images 61 and 62 are initially divided into 8×8 rectangular division areas 65. The division areas 65 are obtained by dividing the non-emission images 60 and the pre-emission images 61 and 62 so as to have the same sections. The number of sections or the shape of the section is not limited to the illustrated example, and may be appropriately changed. Subsequently, a difference is obtained for each division area 65 by subtracting a brightness value Y0 of each division area 65 obtained from the non-emission image 60 from a brightness value Ya of each division area 65 obtained from the first pre-emission image 61. In a case where the difference of each division area is larger than those of the other division areas 65, a set of division areas 65 of which the difference is large is specified as first flash light irradiation areas 67.

In obtaining the non-emission image 60 and the first pre-emission image 61, imaging is obtained with a uniform exposure (with the same exposure) at the time of imaging the images 60 and 61. Alternatively, instead of using the uniform exposure, a brightness value of the other one of the non-emission image 60 and the first pre-emission image 61 in relation to a brightness value of one of the images may be corrected based on exposure differences at the time of imaging the images 60 and 61, and the exposure differences may be corrected through signal processing.

Similarly, the difference is obtained for each division area 65 based on the brightness value Yb of each division area 65 obtained from the second pre-emission image 62 of the second flash device 13 and the brightness value Y0 of each division area 65 obtained from the non-emission image 60. A set of division areas 65 of which the difference is larger than those of the other division areas 65 is specified as second flash light irradiation areas 68. In this case, pre-processing for uniformly adjusting the exposures at the time of obtaining both the images 60 and 62 or post-processing for correcting the brightness value of the other one of both the images 60 and 62 in relation to the brightness value of both the images based on the exposure differences at the time of imaging both the images 60 and 62 is also performed.

For example, the brightness values Ya, Yb, and Y0 are obtained by calculating the brightness values of pixels from the following brightness conversion expression by using signal values R, G, and B of the pixels within each division area.

Y=0.3R+0.6G+0.1B

Subsequently, a brightness value average obtained by averaging the brightness values of the pixels within each division area calculated by the aforementioned brightness conversion expression is calculated. For example, a value to be used is not limited to the aforementioned brightness value as long as the value is a value representing the brightness of each division area, and lightness V in the HSV color space or lightness L in the Lab color space may be used.

On the first pre-emission image 61, the main subject 6 is positioned in the center, and the main subject 6 is mainly irradiated with the flash light (first flash light) from the first flash device 12. Thus, the flash light irradiation areas (first flash light irradiation areas) 67 irradiated with the first flash light are specified as represented as hatched portions on the flash light irradiation area specifying image 63.

On the second pre-emission image 62 of the second flash device 13, the flash light irradiation areas (second flash light irradiation areas) 68 using the second flash device 13 are also specified similarly to the specification of the first flash light irradiation areas 67. On the second pre-emission image 62, since the backdrop 7 is irradiated with the second flash light as shown in FIG. 7, the second flash light irradiation areas 68 are specified as represented as the hatched portions on the flash light irradiation area specifying image 64.

The flash light irradiation area specifying unit 54 obtains the positions of the specified flash light irradiation areas 67 and 68 on the imaging screen, as the coordinate information. The coordinate information is output to the priority area selecting unit 55.

In FIG. 4, in priority area selecting step S14, the priority area selecting unit 55 selects the priority area as the target of the WB adjustment among the flash light irradiation areas 67 and 68. Priority area selecting step S14 includes irradiation area image display step S15 on the rear display unit 23 and a priority area selection input step S16 using the touch panel 24.

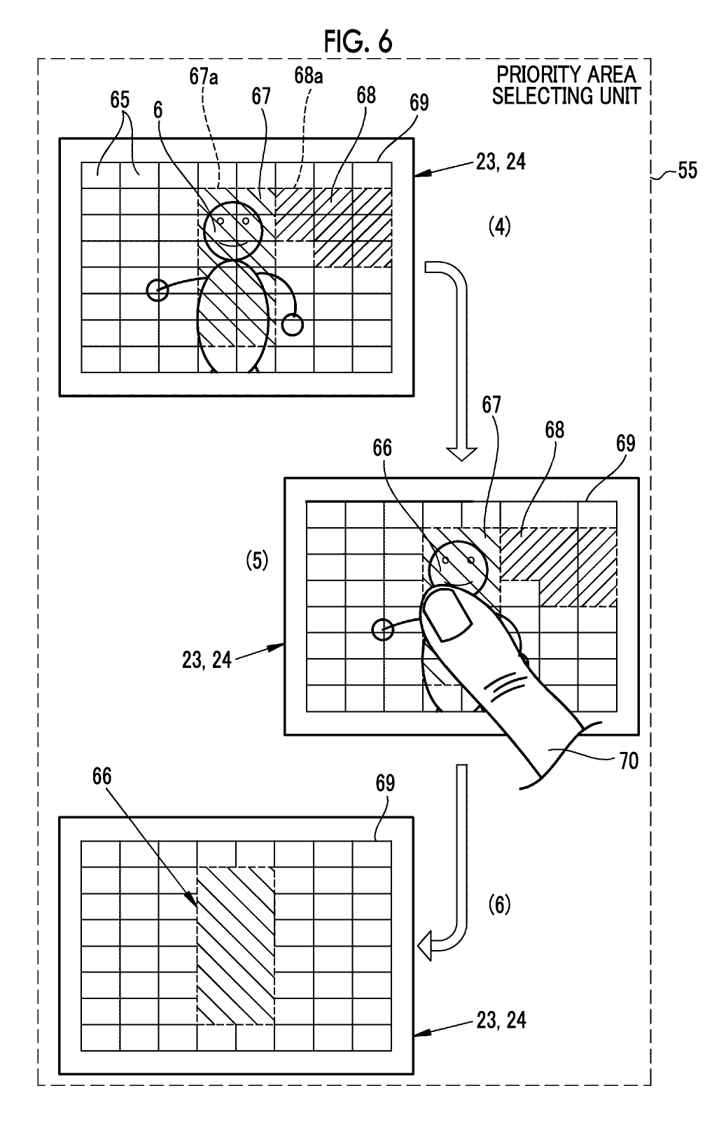

The priority area selecting unit 55 controls the rear display unit 23 through the rear display controller 37, and receives a selection input for the touch panel 24 through the touch panel controller 38. As shown in (4) of FIG. 6, the priority area selecting unit 55 displays a subject image 69 obtained by combining frames 67a and 68a of the flash light irradiation areas 67 and 68 on the rear display unit 23. Specifically, under the control of the priority area selecting unit 55, the rear display controller 37 combines the frames 67a and 68a of the flash light irradiation areas 67 and 68 with the subject image 69 based on the coordinate information from the flash light irradiation area specifying unit 54. For example, the subject image 69 is an image obtained by imaging the same imaging range as that of the non-emission image 60 and the pre-emission images 61 and 62, and a live preview image (referred to as a preview image or a live image) output by the imaging element 28 before the actual imaging.

The flash light irradiation areas 67 and 68 of the subject image 69 are hatched. The flash light irradiation areas are hatched such that the density of hatching varies depending on the brightness value average of each of the flash light irradiation areas 67 and 68, for example, the higher the brightness values, the higher the density of hatching. As shown in (5) of FIG. 6, the user selects the priority area 66 that the user desires to prioritize in the WB adjustment by touching the priority area with a finger 70 while referring to the density of hatching or the position of the main subject 6. The selection is performed by using the touch panel 24. For example, in a case where the flash device 12 of the flash devices 12 and 13 is the flash device to be prioritized, the user designates the flash light irradiation areas 67 using the flash device 12 by touching the flash light irradiation areas with the finger 70. Accordingly, the priority area 66 is determined as shown in (6) of FIG. 6. That is, the touch panel 24 corresponds to a selection input unit that inputs a command to select the priority area 66 to the priority area selecting unit 55. Instead of the hatching display, the touch panel may display the flash light irradiation areas 67 and 68 with the brightness values depending on (for example, in proportion to) the brightness value average of each of the flash light irradiation areas 67 and 68. The priority area 66 selected on the touch panel 24 is not limited to one, and may be prepared in plural.

In the case of the subject image 69 shown in (4) of FIG. 6, it is determined that the brightness of the second flash light irradiation areas 68 including mainly the backdrop 7 is higher than the brightness of the first flash light irradiation areas 67 including the main subject 6 from the hatching display. Thus, the WB adjustment is performed based on the pixels of the second flash light irradiation areas 68 of which the brightness is high in an automatic WB process in the multi-illumination imaging mode of the related art. Accordingly, since the WB adjustment is performed based on the pixels of the backdrop 7, the image of the main subject 6 is shifted from an original tint.

In contrast, in the first embodiment, priority area selection input step S16 is performed by the priority area selecting unit 55. In priority area selection input step S16, the first flash light irradiation areas 67 which are the areas of the main subject 6 are reliably selected as the priority area 66 through the designation using the touching operation of the user on the first flash light irradiation areas 67 with the finger 70, as shown in (5) of FIG. 6. Since the WB adjustment value is calculated based on the priority area 66 which is the areas of the main subject 6, it is possible to allow the main subject 6 to have the appropriate tint.

As shown in FIG. 4, WB adjustment value calculating step S17 and WB adjusting step S18 are performed by the WB adjusting unit 56 of the digital signal processing unit 35. WB adjustment value calculating step S17 is performed by the WB adjustment value calculating unit 59.

WB adjustment value calculating step S17 is performed as follows. Initially, the actual emission for imaging a recording image is performed. The imaging is performed at the time of actual emission by emitting light with an emission amount which is k times an emission amount at the time of pre-emission which is individual emission for obtaining the flash light irradiation areas. K times are determined by the dimming result of the camera or the setting of the user. In a case where it is assumed that the distribution of the brightness values is Yexp(i,j) at the time of the actual emission and the distribution of the brightness values at the time of the non-emission of the flash light which is only the ambient light is Y0(i,j) and it is assumed that representative values obtained by calculating the values within the priority area 66 by using the brightness values through a process such as averaging are Yexp#type and Y0#type, α indicating a ratio of the brightness values using the flash light to the brightness values in the priority area 66 is obtained by the following expression.

α=(Yexp#type−Y0#type)/Yexp#type

In a case where it is assumed that the WB adjustment value of the ambient light is G0 and the WB adjustment value at the time of emitting only the flash light recorded within the camera is Gfl, a WB adjustment value Gwb to be obtained is obtained by the following expression.

Gwb=(Gfl−G0)×α+G0

At the time of actual emission, the subjects 5 are captured in a state in which both the first flash device 12 and the second flash device 13 emit light, and thus, the actual emission image is obtained. The WB adjusting unit 56 performs WB adjusting step S18 as shown in FIG. 4, and adjusts WB by multiplying the signal values R, G, and B of the actual emission image by the WB adjustment value Gwb. Accordingly, a light source color is canceled. The WB adjustment value Gwb is not limited to the aforementioned method, and may be obtained by various methods.

In the present embodiment, since the user selects and inputs the area to be prioritized as the priority area 66, the WB adjustment value is calculated based on the priority area 66 according to the intention of the user, and the WB adjustment is performed. Accordingly, it is possible to allow the image of the main subject 6 to have the appropriate tint at the time of imaging using the plurality of auxiliary light sources.

Although it has been described in the embodiment that two flash devices 12 and 13 are used, three or more flash devices may be used. In this case, the same processes are performed on the priority area using the plurality of flash light rays, and the WB adjustment value Gwb is obtained.

Although it has been described in the present embodiment that the specification of the priority area and the calculation of the WB adjustment value are performed before the actual emission for imaging the recording image, the timing when the specification of the priority area and the calculation of the WB adjustment value are performed is not limited thereto. For example, the specification of the priority area and the calculation of the WB adjustment value may be performed after the actual emission.

Although it has been described in the present embodiment that the selection and specification of the priority area are performed in the WB adjustment by using the touch panel 24, the method of specifying the priority area is not limited thereto, and the selection and the specification of the priority area may be performed by using the operation switch 22 or by using a voice input.

### Second Embodiment

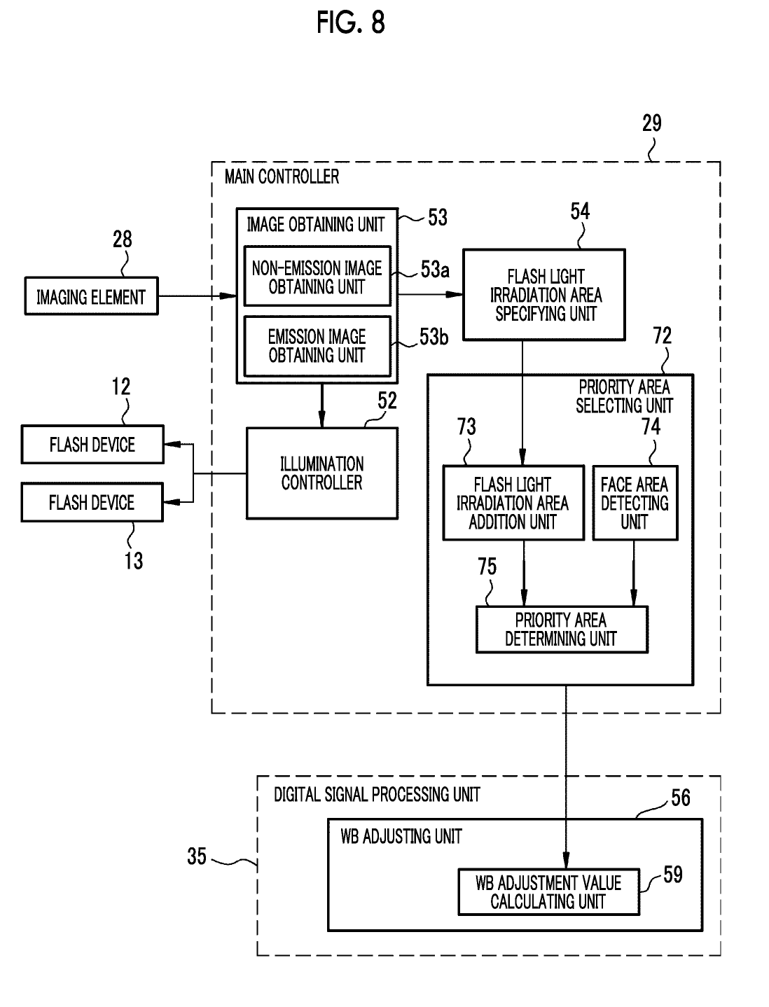

In the first embodiment, the user selects the priority area 66 on the touch panel 24, and thus, the priority area 66 used in the WB adjustment is specified. In contrast, in the second embodiment shown in FIG. 8, a priority area selecting unit 72 includes a flash light irradiation area addition unit (auxiliary light irradiation area addition unit) 73, a face area detecting unit 74, and a priority area determining unit 75. In the following embodiments, the same components and same processing steps as those of the first embodiment will be assigned the same references, and the redundant description thereof will be omitted.

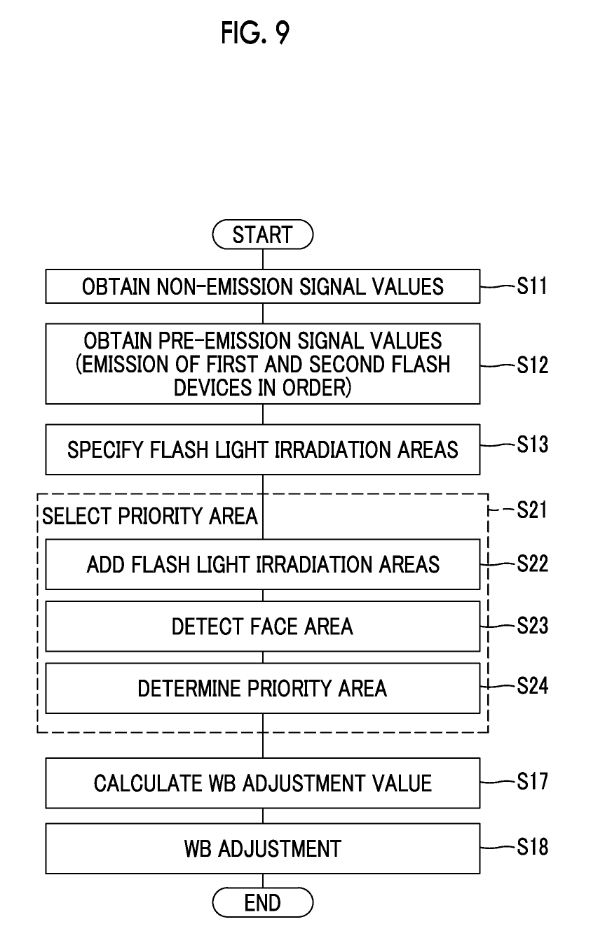

FIG. 9 is a flowchart showing a process procedure according to a second embodiment. Non-emission signal value obtaining step S11, pre-emission signal value obtaining step S12, flash light irradiation area specifying step S13, WB adjustment value calculating step S17, and WB adjusting step S18 are the same processes as those of the first embodiment, and only priority area selecting step S21 is different. Priority area selecting step S21 includes flash light irradiation area addition step S22, face area detecting step S23, and priority area determining step S24.

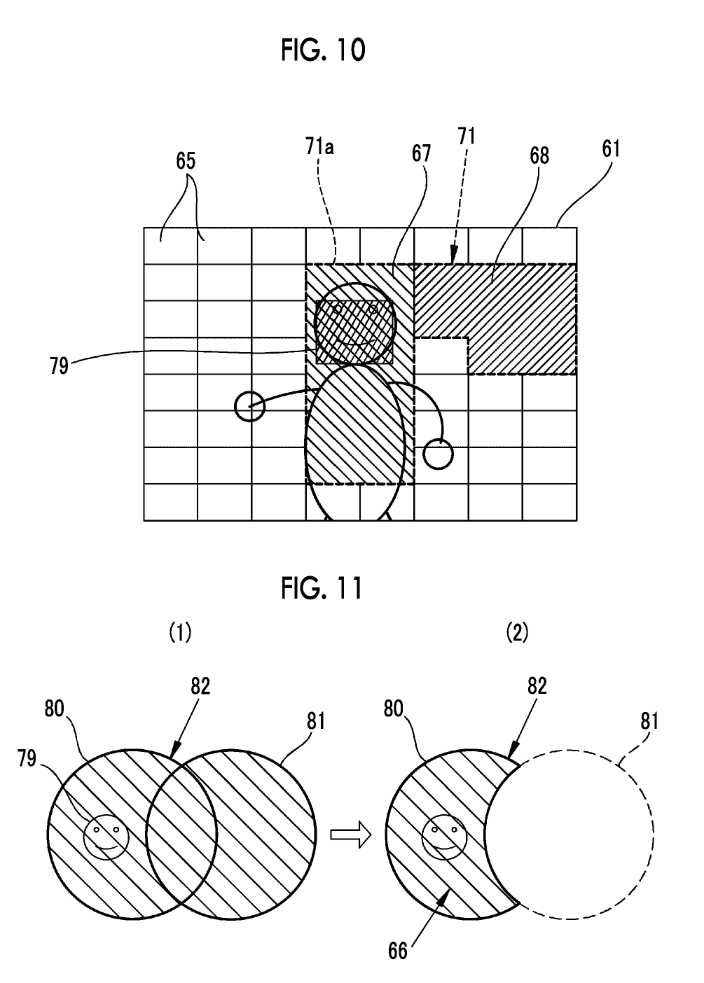

In flash light irradiation area addition step S22, an addition area 71 is calculated by adding the flash light irradiation areas 67 and 68, as shown in FIG. 10. The addition refers that a logical disjunction of the flash light irradiation areas 67 and 68 is obtained, and an area surrounded by a frame border 71a is the addition area 71.

In the face area detecting step S23, the face area detecting unit 74 detects a face area 79 of the person from the first pre-emission image 61, as shown in FIG. 10. The division areas (division areas smaller than the division areas 65 by increasing the number of divisions) having the size smaller than that of the division areas 65 used at the time of obtaining the flash light irradiation areas 67 and 68 are preferably used in the detection of the face area 79. The face area 79 may be detected from the non-emission image 60 or the second pre-emission image 62.

In priority area determining step S24, the priority area determining unit 75 specifies which of the flash light irradiation areas 67 and 68 the face area 79 detected by the face area detecting unit 74 is present. The flash light irradiation areas 68 which do not include the face area 79 are excluded from the addition area 71. The flash light irradiation area 67 remaining after the excluding is determined as the priority area.

The priority area determining unit 75 obtains information of which of the first flash light irradiation areas 67 and the second flash light irradiation areas 68 the face area 79 detected by the face area detecting unit 74 is present from coordinates representing the mutual positions of these areas on the image. Similarly to the first embodiment, the WB adjustment is performed after the priority area is specified.

The face area 79 is detected based on areas indicating the flesh color of the person. In addition, the face area 79 may be detected by a method using shape recognition of eyes, nose, and mouth, a method using combination of the flesh area and the shape recognition, or various face recognition methods.

In the present embodiment, it is possible to specify the priority area by automatically detecting the face area 79, and since the user does not need to select the priority area unlike the first embodiment, usability is improved.

As shown in FIG. 11, in a case where a plurality of flash light irradiation areas 80 and 81 is overlapped, the flash light irradiation area 81 which does not include the face area 79 is excluded from the hatched addition area 82, and a part of the remaining flash light irradiation area 80 is the priority area 66.

### Third Embodiment

As shown in FIG. 12, there are some cases where imaging is performed in the studio by attaching a special effect filter 83 to an irradiation surface of the flash device 13 and projecting a color or a pattern on the background. There are many cases where commemorative images are captured on the seasons of the year and occasions, and the special effect filter 83 is used such that a background color varies depending on each season of the year or each occasion in the imaging in the studio. For example, in a case where an image commemorative of entrance into a school is captured in a school entrance ceremony on April, the special effect filter 83 for giving an effect such that the background is in pink or the special effect filter 83 for giving an effect such that cherry blossoms are scattered is used in order to express cherry blossoms in full bloom. The priority area in the imaging in the studio using the special effect filter 83 may be automatically selected by excluding the irradiation area using the flash device for background.

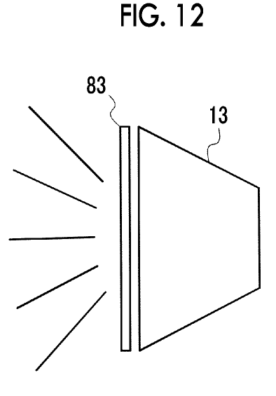

In a third embodiment, a priority area selecting unit 84 includes a flash light irradiation area addition unit 73 and a priority area determining unit 85, as shown in FIG. 13. The priority area determining unit 85 includes an ambient light coordinate calculating unit 87, a flash light recording unit 88, a difference vector calculating unit 89, a non-emission signal value average calculating unit 90 that calculates the average of the signal values at the time of the non-emission of the flash light irradiation areas, a pre-emission signal value average calculating unit 91 that calculates the average of the signal values at the time of the pre-emission of the flash light irradiation areas, a signal value average prediction value calculating unit 92, and a special-effect flash light determining unit 93. The priority area determining unit 85 identifies that the flash light is the flash light using the special effect filter 83, excludes the area irradiated with the flash light using the special effect filter 83 from the addition area, and selects the addition area remaining after the excluding as the priority area.

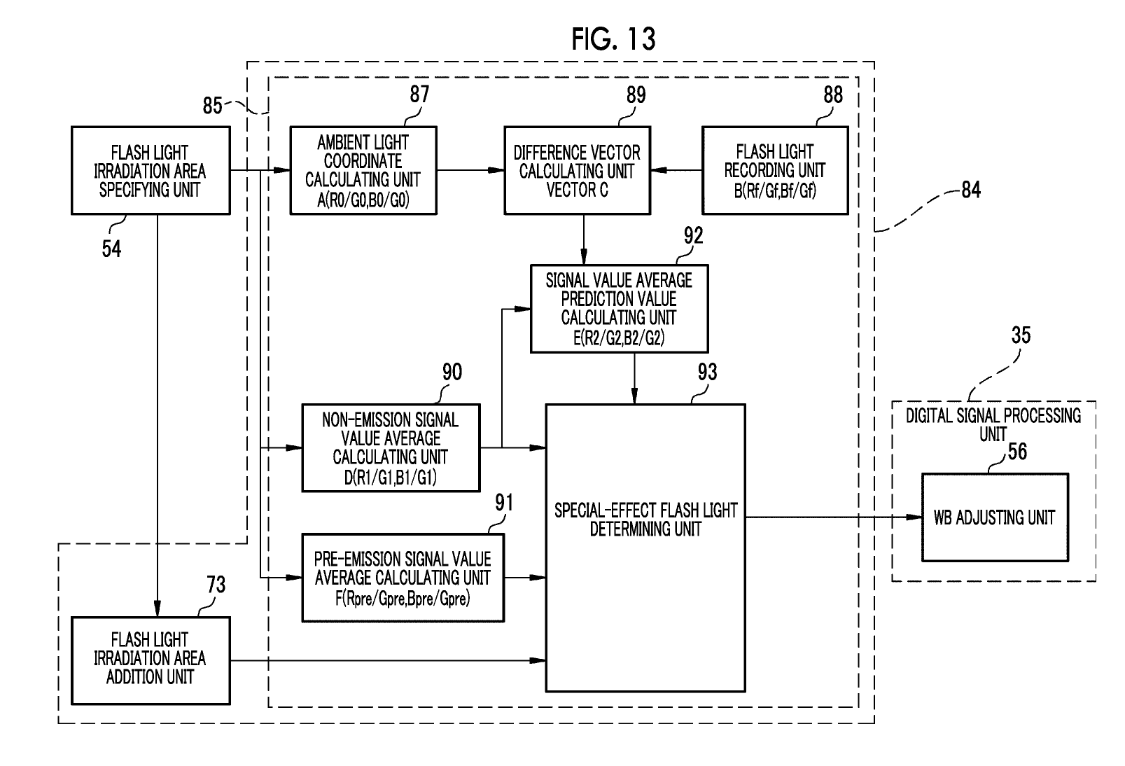

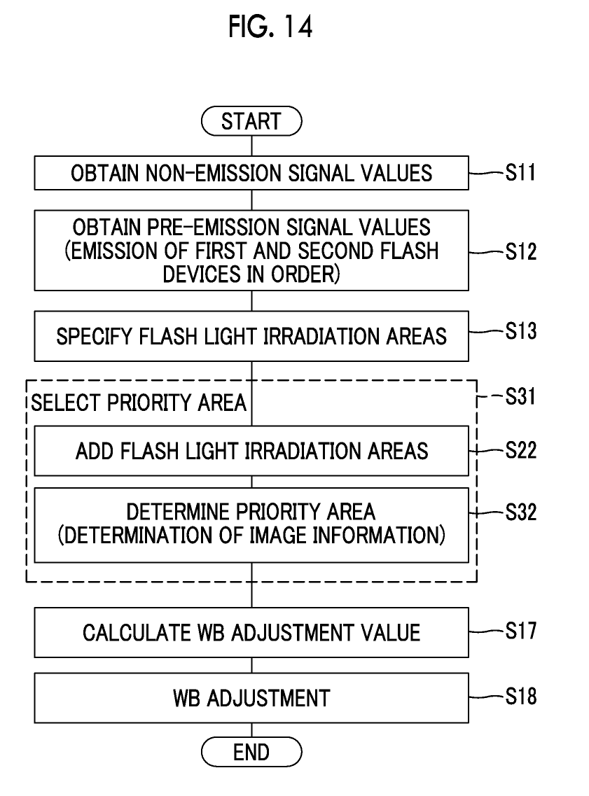

FIG. 14 is a flowchart showing a process procedure according to the third embodiment. Non-emission signal value obtaining step S11, pre-emission signal value obtaining step S12, flash light irradiation area specifying step S13, WB adjustment value calculating step S17, and WB adjusting step S18 are the same processes as those of the first embodiment, and only priority area selecting step S31 is different. Priority area selecting step S31 is performed by the priority area selecting unit 84, and includes flash light irradiation area addition step S22 and priority area determining step S32 of determining the priority area through the determination of the image information. In priority area determining step S32, the processes to be described below are performed, and the priority is determined.

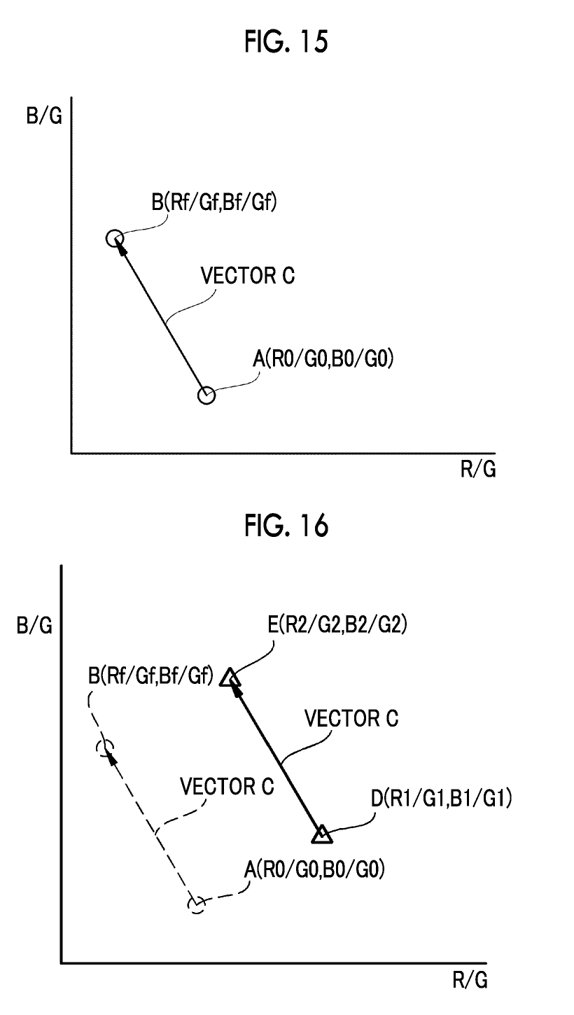

Light source coordinates (R0/G0, B0/G0) at a point A representing light source color information of the ambient light in a color space having R/G and B/G on a coordinate axis are calculated based on the signal value of the non-emission image by the ambient light coordinate calculating unit 87, as shown in FIG. 15.

Subsequently, light source coordinates (Rf/Gf, Bf/Gf) at a point B representing the light source color information of the flash light in the same color space are calculated in advance, and are stored in a nonvolatile memory by the flash light recording unit 88. Subsequently, a vector C which is a difference therebetween is calculated based on the coordinates (R0/G0, B0/G0) at the point A and the coordinates (Rf/Gf, Bf/Gf) at the point B by the difference vector calculating unit 89. The vector C is output to the signal value average prediction value calculating unit 92.

Subsequently, signal value averages R1, G1, and B1 (corresponding to the pixel information at the time of the non-emission of the auxiliary light irradiation areas) at the time of the non-emission of the flash light irradiation areas are calculated, and coordinates (R1/G1, B1/G1) at a point D in the color space are calculated by the non-emission signal value average calculating unit 90, as shown in FIG. 16. The coordinates (R1/G1, B1/G1) at the point D are output to the signal value average prediction value calculating unit 92 and the special-effect flash light determining unit 93.

Subsequently, coordinates (R2/G2, B2/G2) at a point E in the color space which indicate prediction values R2, G2, and B2 of the signal value averages at the time of performing the irradiation using only the flash light in a state in which there is no special effect filter 83 and there is no ambient light in the same flash light irradiation areas are calculated from the following expression by the signal value average prediction value calculating unit 92. Here, the prediction values R2, G2, and B2 correspond to the signal value average prediction values at the time of the emission of the auxiliary light source.

(R2/G2,B2/G2)=(R1/G1,B1/G1)+C

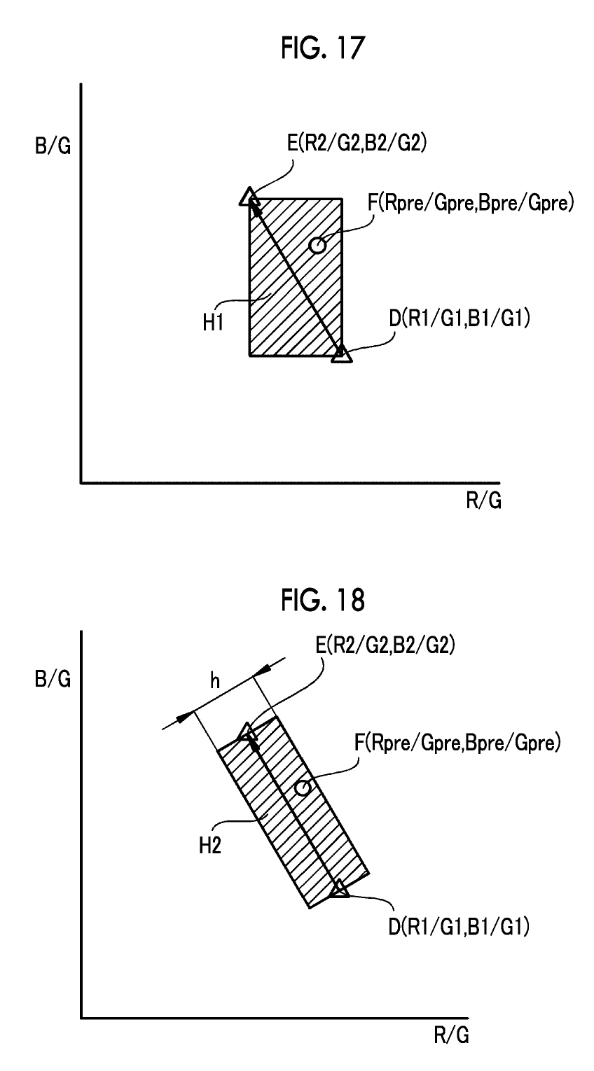

Subsequently, signal value averages Rpre, Gpre, and Bpre (corresponding to pixel information based on the emission image) in the flash light irradiation areas of the pre-emission image are obtained by the pre-emission signal value average calculating unit 91, and coordinates (Rpre/Gpre, Bpre/Gpre) at a point F in the color space which indicate the signal value averages Rpre, Gpre, and Bpre at the time of the pre-emission are calculated as shown in FIG. 17. The coordinates (Rpre/Gpre, Bpre/Gpre) at the point F are output to the special-effect flash light determining unit 93.

Thereafter, the special-effect flash light determining unit 93 determines whether or not the flash light is the flash light using the special effect filter 83 based on the coordinates (Rpre/Gpre, Bpre/Gpre) at the point F. In a case where the coordinates (Rpre/Gpre, Bpre/Gpre) at the point F are present in a rectangular determination range H1 using the point D indicated by the non-emission signal value average coordinates (R1/G1, B1/G1) and the point E indicated by the flash-emission signal value average prediction coordinates (R2/G2, B2/G2) as both ends of a diagonal line, the special-effect flash light determining unit 93 determines that the flash light is the normal flash light (color temperature: 5000 to 6000K) without using the special effect filter 83. In contrast, in a case where the coordinates (Rpre/Gpre, Bpre/Gpre) at the point F are present in the determination range H1, it is determined that the flash device is the flash device to which the special effect filter 83 is attached. Accordingly, in a case where the flash device is the flash device to which the special effect filter 83 is attached, the irradiation area using this flash device is excluded from the addition area, and the remaining addition area is determined as the priority area.

Since the irradiation areas of the flash light using the special effect filter 83 are excluded from the selection target of the priority area and the remaining irradiation area is selected as the priority area, the irradiation areas of the flash light using the special effect filter 83 that is frequently used in the illumination of the background are reliably excluded from the selection candidate of the priority area, and the irradiation areas of the flash light output to the main subject 6 such as the person are selected as the priority areas. Accordingly, the main subject 6 can have the appropriate tint.

For example, in a case where there is the plurality of flash light irradiation areas determined as the priority areas, it is determined that the flash light irradiation area having a high brightness value average is the priority area. It is determined that the area having a high light amount set ratio of the user is the priority area. It may be determined that the plurality of flash light irradiation areas is the priority areas instead of the selecting any one thereof as stated above.

In a case where there is the plurality of flash light irradiation areas determined as the priority areas, the WB adjustment value Gwb is obtained as follows.

For example, in a case where two priority areas are used and it is initially assumed that distributions of brightness values of (i×j) number of divided blocks (division areas 65, i=1 to 8 in the present example) at the time of individually emitting first priority flash light and second priority flash light are Ypre1 (i, j) and Ypre2(i, j) and a distribution of brightness values at the time of non-emission (=only the ambient light) is Y0(i, j), distributions ΔYpre1(i, j) and ΔYpre2(i, j) of brightness values increased by the first and second priority flash light rays are respectively obtained by the following expressions.

ΔYpre1(i,j)=Ypre1(i,j)−Y0(i,j)

ΔYpre2(i,j)=Ypre2(i,j)−Y0(i,j)

In a case where the brightness values are increased by only the first priority flash light and the second priority flash light at the time of actual emission, the distribution ΔYexp(i, j) of the brightness values to be expected is obtained as follows. K1 is obtained from (emission amount at the time of actual emission)/(emission amount at the time of pre-emission) of the first priority flash light, and K2 is obtained from (emission amount at the time of actual emission)/(emission amount at the time of pre-emission) of the second priority flash light.

ΔYexp(i,j)=K1×ΔYpre1(i,j)+K2×ΔYpre2(i,j)

Similarly to the case where one priority area is used, the distributions of the brightness values Yexp(i, j) and Y0(i, j) to be expected, the representative values of the priority areas Yexp#type and Y0#type, a indicating a ratio of the brightness values using the priority flash light to the brightness values in the priority areas, and so on are calculated based on the distribution ΔYexp(i, j) of the brightness values corresponding to the obtained increase amount, and the WB adjustment value Gwb is ultimately obtained. The WB adjustment is performed based on the WB adjustment value Gwb as described above.

### Modification Example 1

Although it has been described in the third embodiment that the rectangular determination range H1 is used as shown in FIG. 17, a rectangular determination range H2 defined by a width h in a direction perpendicular to a line segment that connects the point D with the point E is used in Modification Example 1 shown in FIG. 18. For example, as a length which is 30% of a length of the line segment DE is used as the width h. Specifically, the width h is set to a value with which WB performance is the best.

### Modification Example 2

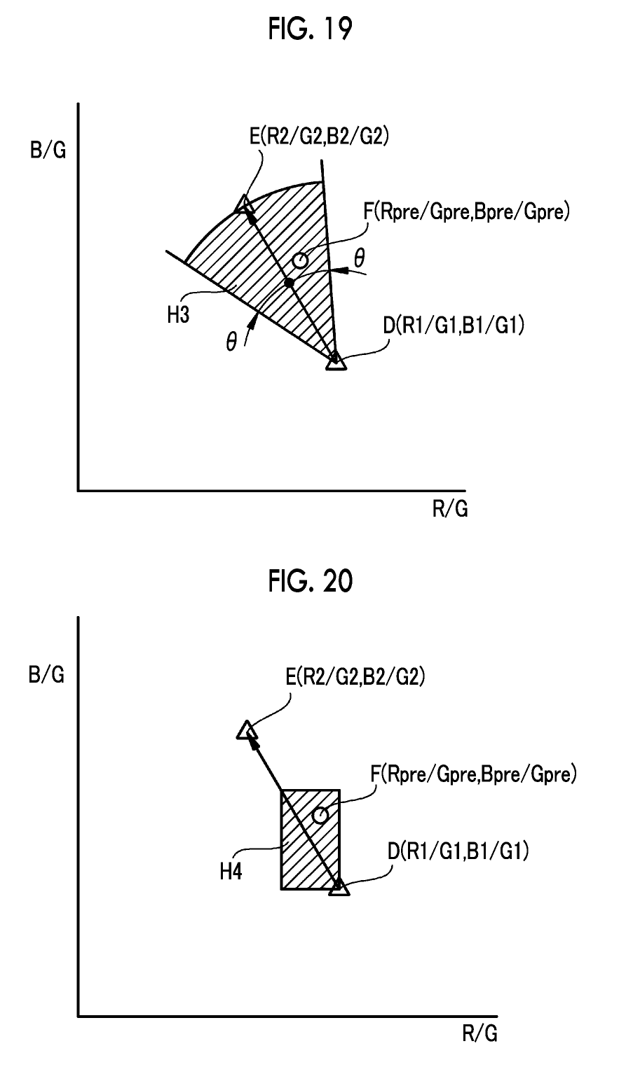

In Modification Example 2 shown in FIG. 19, a sector-shaped (fan-shaped) determination range H3 divided up by a predetermined angle θ with respect to the line segment that connects the point D with the point E with the point D as a reference is used. The angle is set to a value with which the WB performance is the best.

### Modification Examples 3 to 5

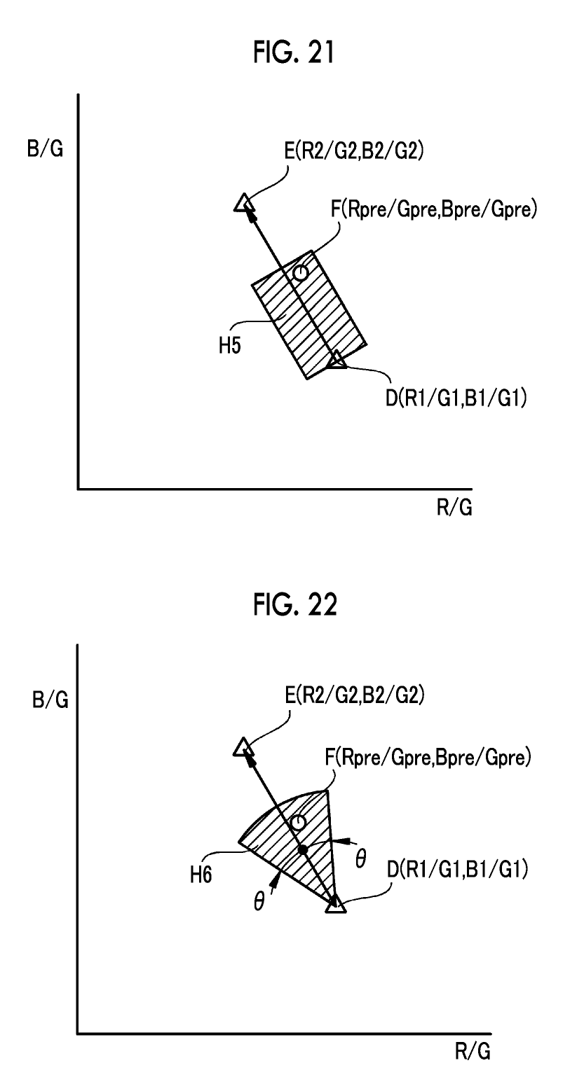

In Modification Example 3 shown in FIG. 20, a determination range H4 obtained by multiplying the vector C by a reduction ratio β (β<1) and further reducing the length than the vector C in the determination range H1 shown in FIG. 17 is used. Similarly, in Modification Example 4 shown in FIG. 21, a determination range H5 obtained by multiplying the length of the line segment DE by the reduction ratio β and further reducing the length than the line segment DE in the determination range H2 of Modification Example 1 shown in FIG. 18 is used. Similarly, in Modification Example 5 shown in FIG. 22, a sector-shaped determination range H6 obtained by multiplying the length of the line segment DE by the reduction ratio β and further reducing the length than the line segment DE in the determination range H3 of Modification Example 2 shown in FIG. 19 is used.

The reduction ratio β is obtained by the following expression.

β=(Ypre−Y0)/Ypre

Ypre is a brightness value average at the time of the pre-emission of the flash light irradiation areas, and Y0 is similarly a brightness value average at the time of the non-emission of the flash light irradiation areas. For example, it is preferable that a margin is given to the reduction ratio β by using a value β1 (=β×1.2) obtained by multiplying β by 1.2.

As in Modification Examples 1 to 5, it is possible to more strictly determine whether or not the flash light is the flash light of the flash device to which the special effect filter 83 is attached by obtaining the determination ranges H2 to H6 other than the determination range H1 shown in FIG. 17.

Although it has been described in the third embodiment that the area is determined as the priority area in a case where the emission signal value average is present in the range including a non-emission signal value average and a flash-light-emission signal value average prediction value as both ends, the second embodiment is not limited to this determination method. For example, the priority area may be determined based on the previously stored pixel information of the flash light.

### Fourth Embodiment

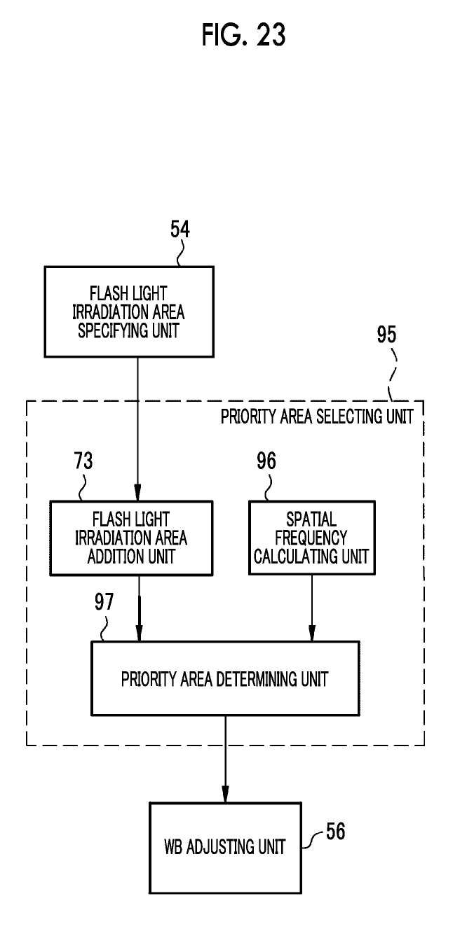

In a fourth embodiment, a priority area selecting unit 95 includes a spatial frequency calculating unit 96 and a priority area determining unit 97, and determines whether or not the background is irradiated with the flash light by the priority area determining unit 97 based on the spatial frequency calculated by the spatial frequency calculating unit 96, as shown in FIG. 23.

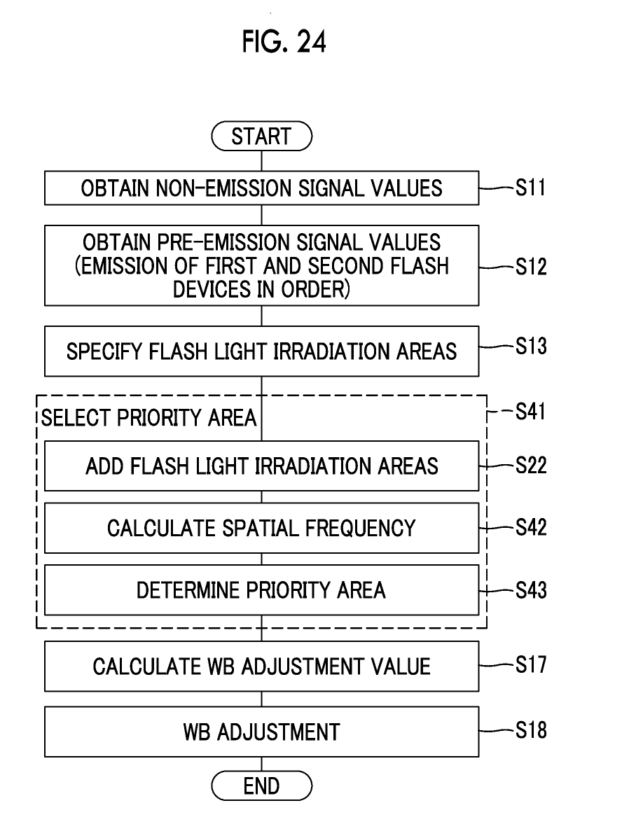

FIG. 24 is a flowchart showing a process procedure according to the fourth embodiment. Non-emission signal value obtaining step S11, pre-emission signal value obtaining step S12, flash light irradiation area specifying step S13, WB adjustment value calculating step S17, and WB adjusting step S18 are the same processes as those of the first embodiment, and only priority area selecting step S41 is different. In priority area selecting step S41, flash light irradiation area addition step s22, spatial frequency calculating step S42, and priority area determining step S43 are performed.

In spatial frequency calculating step S42, spatial frequencies of the flash light irradiation areas 67 and 68 on the non-emission images 60 using the flash devices 12 and 13 are calculated by the spatial frequency calculating unit 96. In priority area determining step S43, in a case where the calculated spatial frequencies of the flash light irradiation areas 67 and 68 using the flash devices 12 and 13 are equal to or smaller than a predetermined value, the priority area determining unit 97 excludes the flash light irradiation areas having the spatial frequency equal to or smaller than the predetermined value from the addition area. There are many cases where the backdrop 7 is a plain screen, and there are some cases where the spatial frequency is equal to or smaller than the predetermined value. Accordingly, in the present example, the flash light irradiation areas 68 irradiated with the backdrop 7 are excluded, and the flash light irradiation area 67 remaining after the excluding is selected as the priority area.

In a case where there is the plurality of flash light irradiation areas remaining after the excluding, the flash light irradiation area having a high brightness value average in the flash light irradiation areas is determined as the priority area. All the plurality of remaining flash light irradiation areas may be determined as the priority areas instead of determining only one priority area.

Since the flash light irradiation areas whose spatial frequency is equal to or smaller than the predetermined value are excluded from the selection candidate of the priority area and the irradiation area remaining after the excluding is determined as the priority area, the irradiation areas of the flash light radiated to the backdrop 7 are reliably excluded from the selection target of the priority area, and the irradiation area of the flash light radiated to the main subject 6 is selected as the priority area. Accordingly, the main subject 6 can have the appropriate tint.

In the embodiments, the hardware structure of the processing units that perform various processing such as the non-emission image obtaining unit 53a, the emission image obtaining unit 53b, the flash light irradiation area specifying unit (auxiliary light irradiation area specifying unit) 54, the priority area selecting unit 55, 72, 84, or 95, the WB adjustment value calculating unit 59, the WB adjusting unit 56, the flash light irradiation area addition unit (auxiliary light irradiation area addition unit) 73, the face area detecting unit 74, the priority area determining unit 75, 85, or 97, and the spatial frequency calculating unit 96 is realized by various processors as follows. The various processors include a central processing unit (CPU) which is a general-purpose processor functioning as various processing units by executing software (program), a programmable logic device (PLD) which is a processor capable of changing a circuit configuration after a field-programmable gate array (FPGA) is manufactured, and a dedicated electric circuit which is a processor having a dedicated circuit configuration designed for performing a specific process such as an Application-Specific Integrated Circuit (ASIC).

One processing unit may be constituted by one of the various processors, or may be constituted by a combination (for example, a combination of a plurality of FPGAs or a combination of the CPU and the FPGA) of two or processors of the same type or different types. The plurality of processing units may be constituted by one processor. An example in which the plurality of processing units is constituted by one processor is as follows. Firstly, one processor is constituted by a combination of one or more CPUs and software, and this processor functions as the plurality of processing units. Secondly, a processor that realizes all the functions of the system including the plurality of processing units by using one integrated circuit (IC) chip, such as system on chip (SoC), is used. As stated above, the various processing units are constituted by one or more processors of the various processors as a hardware structure.

More specifically, the hardware structure of the various processors is an electric circuitry obtained by combining circuit elements such as semiconductor elements.

From the above description, it is possible to ascertain the invention represented by the following appendix.

[Appendix 1]

There is provided a white balance adjusting apparatus including a non-emission image obtaining processor that obtains a non-emission image by imaging a subject in a state in which a plurality of auxiliary light sources does not emit light, an emission image obtaining processor that obtains emission images of the auxiliary light sources by imaging the subject in a state in which the plurality of auxiliary light sources individually emits light, an auxiliary light irradiation area specifying processor that divides the non-emission image and each of the emission images into a plurality of division areas, and specifies auxiliary light irradiation areas irradiated with auxiliary light of each of the auxiliary light sources based on a signal value difference of each division area between the state in which the plurality of auxiliary light sources individually emits light and the state in which the plurality of auxiliary light sources does not emit light, a priority area selecting processor that selects a priority area to be used in white balance adjustment from the auxiliary light irradiation areas of each of the auxiliary light sources, a white balance adjustment value calculating processor that calculates a white balance adjustment value based on a signal value of the selected priority area, and a white balance adjusting processor that performs adjustment using the white balance adjustment value.

The present invention is not limited to the embodiments or the modification examples, and may adopt various configurations without departing from the gist of the present invention. For example, the embodiments or the modification examples may be appropriately combined.

The present invention is applicable to an imaging device such as a mobile phone or a smartphone in addition to the camera 11.

### EXPLANATION OF REFERENCES

5: subject
6: main subject
7: backdrop
9: imaging studio
10: imaging system
11: digital camera (camera)
11a: camera main body
12: first flash device (auxiliary light source)
13: second flash device (auxiliary light source)
14: flash light emitting unit
15, 16: wireless communication I/F
17: flash controller
18: flash light emitting unit
21: lens barrel
22: operation switch
23: rear display unit
24: touch panel
25: imaging optical system
26: stop
27: shutter
28: imaging element
29: main controller
30: flash controller
33: bus
34: memory controller
35: digital signal processing unit
36: media controller
37: rear display controller
38: touch panel controller
39: memory
40: recording media
41: shutter drive unit
45: operation program
52: illumination controller
53: image obtaining unit
53a: non-emission image obtaining unit
53b: emission image obtaining unit
54: flash light irradiation area specifying unit
55: priority area selecting unit
56: WB adjusting unit (white balance adjusting unit)
59: WB adjustment value calculating unit (white balance adjustment value calculating unit)
60: non-emission image
61, 62: first and second pre-emission images
63, 64: flash light irradiation area specifying image
65: division area
66: priority area
67: first flash light irradiation area
67a: frame
68: second flash light irradiation area
68a: frame
69: subject image
70: finger
71: addition area
71a: frame border
72: priority area selecting unit
73: flash light irradiation area addition unit (auxiliary light irradiation area addition unit)
74: face area detecting unit
75: priority area determining unit
79: face area
80, 81: flash light irradiation area
82: addition area
83: special effect filter
84: priority area selecting unit
85: priority area determining unit
87: ambient light coordinate calculating unit
88: flash light recording unit
89: difference vector calculating unit
90: non-emission signal value average calculating unit
91: pre-emission signal value average calculating unit
92: signal value average prediction value calculating unit
93: special-effect flash light determining unit
95: priority area selecting unit
96: spatial frequency calculating unit
97: priority area determining unit
A: light source coordinates of ambient light source
B: light source coordinates of flash light
C: vector
D: non-emission signal value average of flash light irradiation area
DE: line segment
E: signal value average prediction value at the time of emitting only flash of flash light irradiation area
H1 to H6: determination range
LA: optical axis
h: width
θ: angle
S11: non-emission signal value obtaining step
S12: pre-emission signal value obtaining step
S13: flash light irradiation area specifying step (auxiliary light irradiation area specifying step)
S14: priority area selecting step
S15: irradiation area image display step
S16: priority area selection input step
S17: WB adjustment value calculating step (white balance adjustment value calculating step)
S18: WB adjusting step (white balance adjusting step)
S21, S31, S41: priority area selecting step
S22: flash light irradiation area addition step
S23: face area detecting step
S24: priority area determining step
S32: priority area determining step
S42: spatial frequency calculating step
S43: priority area determining step

What is claimed is:

1. A white balance adjusting apparatus comprising:
a non-emission image obtaining unit that obtains a non-emission image by imaging a subject in a state in which a plurality of auxiliary light sources does not emit light;
an emission image obtaining unit that obtains emission images of the auxiliary light sources by imaging the subject in a state in which the plurality of auxiliary light sources individually emits light;
an auxiliary light irradiation area specifying unit that divides the non-emission image and each of the emission images into a plurality of division areas, and specifies auxiliary light irradiation areas irradiated with auxiliary light of each of the auxiliary light sources based on a signal value difference of each division area between the state in which the plurality of auxiliary light sources individually emits light and the state in which the plurality of auxiliary light sources does not emit light;
a priority area selecting unit that selects a priority area to be used in white balance adjustment from the auxiliary light irradiation areas of each of the auxiliary light sources;
a white balance adjustment value calculating unit that calculates a white balance adjustment value based on a signal value of the selected priority area; and
a white balance adjusting unit that performs adjustment using the white balance adjustment value.

2. The white balance adjusting apparatus according to claim 1, further comprising:
a selection input unit that inputs a command to select one or a plurality of the priority areas from the auxiliary light irradiation areas of each of the auxiliary light sources to the priority area selecting unit.

3. The white balance adjusting apparatus according to claim 1,
wherein the priority area selecting unit includes
an auxiliary light irradiation area addition unit that calculates an addition area obtained by adding the auxiliary light irradiation areas,
a face area detecting unit that detects a face area from the non-emission image or the emission image, and
a priority area determining unit that specifies which of the auxiliary light irradiation areas the face area detected by the face area detecting unit is present, excludes the auxiliary light irradiation areas which do not include the face area from the addition area, and determines that the area remaining after the excluding is the priority area.

4. The white balance adjusting apparatus according to claim 1,
wherein the priority area selecting unit includes
an auxiliary light irradiation area addition unit that calculates an addition area obtained by adding the auxiliary light irradiation areas, and
a priority area determining unit that determines the priority area based on previously stored pixel information of the auxiliary light source and the addition area.

5. The white balance adjusting apparatus according to claim 4,
wherein the priority area determining unit sets a determination range in a color space by using the previously stored light source color information of the auxiliary light, light source color information of ambient light obtained from the non-emission image, and pixel information at the time of non-emission of the auxiliary light irradiation areas, and excludes the auxiliary light irradiation areas from the addition area and determines that the area remaining after the excluding is the priority area in a case where pixel information based on the emission image is positioned out of the determination range.

6. The white balance adjusting apparatus according to claim 5,
wherein the light source color information of the auxiliary light is coordinates indicating a color of the auxiliary light in a color space,
the light source color information of the ambient light is coordinates which are obtained based on the non-emission image and indicate a color of the ambient light in the color space,
the pixel information at the time of the non-emission of the auxiliary light irradiation areas is coordinates which are obtained based on the non-emission image and indicate a non-emission signal value average of the auxiliary light irradiation areas in the color space, and
the priority area determining unit calculates a difference vector which is a difference between the coordinates of the auxiliary light and the coordinates of the ambient light, obtains a signal value average prediction value at the time of emission of the auxiliary light source by adding the difference vector to the coordinates of the non-emission signal value average, calculates an emission signal value average which is a signal value average of the auxiliary light irradiation areas in the color space based on the emission image, and determines the priority area based on the non-emission signal value average, a signal value average prediction value at the time of the emission of the auxiliary light source, and the emission signal value average.

7. The white balance adjusting apparatus according to claim 6,
wherein, in a case where the emission signal value average is present out of the determination range having the non-emission signal value average and the signal value average prediction value at the time of the emission of the auxiliary light source as both ends, the priority area determining unit excludes the auxiliary light irradiation areas from the addition area, and selects the area remaining after the excluding as the priority area.

8. The white balance adjusting apparatus according to claim 1,
wherein the priority area selecting unit includes
an auxiliary light irradiation area addition unit that calculates an addition area obtained by adding the auxiliary light irradiation areas,
a spatial frequency calculating unit that calculates a spatial frequency of the auxiliary light irradiation areas using each of the auxiliary light sources on the non-emission image, and
a priority area determining unit that excludes the auxiliary light irradiation areas whose spatial frequency is equal to or smaller than a predetermined value from the addition area and determines that the area remaining after the excluding is the priority area, in a case where the spatial frequency of the auxiliary light irradiation areas using each of the auxiliary light sources is equal to or smaller than the predetermined value.

9. The white balance adjusting apparatus according to claim 1,
wherein the white balance adjustment value calculating unit obtains an emission image at the time of actual emission obtained by imaging the subject in a state in which the auxiliary light source emits light, and calculates the white balance adjustment value based on a signal value in the priority area of the emission image and a signal value in the priority area of the non-emission image.

10. The white balance adjusting apparatus according to claim 1,
wherein the white balance adjusting unit obtains an actual emission image obtained by imaging the subject in a state in which the plurality of auxiliary light sources emits light with an emission amount at the time of actual emission, and performs the white balance adjustment using the white balance adjustment value on the actual emission image.

11. An operation method of a white balance adjusting apparatus, the method comprising:
a non-emission image obtaining step of obtaining a non-emission image by imaging a subject in a state in which a plurality of auxiliary light sources does not emit light;
an emission image obtaining step of obtaining emission images of the auxiliary light sources by imaging the subject in a state in which the plurality of auxiliary light sources individually emits light;
an auxiliary light irradiation area specifying step of dividing the non-emission image and each of the emission images into a plurality of division areas, and specifying auxiliary light irradiation areas irradiated with auxiliary light of each of the auxiliary light sources based on a signal value difference of each division area between the state in which the plurality of auxiliary light sources individually emits light and the state in which the plurality of auxiliary light sources does not emit light;
a priority area selecting step of selecting a priority area to be used in white balance adjustment from the auxiliary light irradiation areas of each of the auxiliary light sources;
a white balance adjustment value calculating step of calculating a white balance adjustment value based on a signal value of the selected priority area; and
a white balance adjusting step of performing adjustment using the white balance adjustment value.

12. A non-transitory computer readable medium for storing a computer-executable program for execution of white balance adjustment, the computer-executable program causing a computer to perform:
a non-emission image obtaining step of obtaining a non-emission image by imaging a subject in a state in which a plurality of auxiliary light sources does not emit light;
an emission image obtaining step of obtaining emission images of the auxiliary light sources by imaging the subject in a state in which the plurality of auxiliary light sources individually emits light;
an auxiliary light irradiation area specifying step of dividing the non-emission image and each of the emission images into a plurality of division areas, and specifying auxiliary light irradiation areas irradiated with auxiliary light of each of the auxiliary light sources based on a signal value difference of each division area between the state in which the plurality of auxiliary light sources individually emits light and the state in which the plurality of auxiliary light sources does not emit light;
a priority area selecting step of selecting a priority area to be used in white balance adjustment from the auxiliary light irradiation areas of each of the auxiliary light sources;
a white balance adjustment value calculating step of calculating a white balance adjustment value based on a signal value of the selected priority area; and
a white balance adjusting step of performing adjustment using the white balance adjustment value.
